(19) United States
(12) Patent Application Publication
(10) Pub. No.: US 2023/0209346 A1
(43) Pub. Date: Jun. 29, 2023

(54) SYSTEMS AND METHODS FOR ACCESSING A WIRELESS NETWORK

(71) Applicant: Comcast Cable Communications, LLC, Philadelphia, PA (US)

(72) Inventors: Jacob Gladish, Blue Bell, PA (US); Evgeniy Strokin, Newtown, PA (US)

(21) Appl. No.: 17/645,923

(22) Filed: Dec. 23, 2021

(51) Int. Cl. H04W 12/08; H04W 12/06

(52) U.S. Cl. CPC H04W 12/08; H04W 12/06

(57) ABSTRACT

A network access manager of a local network may be used to provide access to unauthorized users on the local network. A request may be received from an authorized user of the network to allow the unauthorized users access to the network. A message may be sent to the unauthorized users to invite the unauthorized users to join the network. An authentication token may be received by the network access manager that authenticates the identity of one of the unauthorized users. The network access manager may validate the identity of the unauthorized user using the authentication token. The network access manager may provide a credential required to access the network to the unauthorized user. The unauthorized user may join the network using the credential.

### BACKGROUND

In order to provide wireless network access to unauthorized users, an authorized user on the network typically supplies the unauthorized user with a wireless network access credential, such as a password, and the unauthorized user may enter the credential in order to gain access to the network. This process can be cumbersome. Sometimes multiple unauthorized users request access at the same time, and the authorized user must help each unauthorized user through the process. Also, the process sometimes needs to be repeated every time the same unauthorized user attempts to access the network. Improvements in managing wireless network access are needed.

### SUMMARY

Systems, methods, and apparatus for providing access to a wireless network are described herein. An authorized user (e.g., an owner) of a wireless network may desire to provide access to the network to one or more other users that are unauthorized to access the network. The authorized user may send a request to a computing device on the network indicating that the one or more other users should be provided access to the network. The computing device may comprise, for example, a network access manager. The network access manager may determine a credential for accessing the network and may send a message to each of the other users comprising an invitation to access the network. The message may comprise an address, such as a uniform resource locator (URL), associated with a network location from which one or more of the other users may initiate a process of joining the network. The message may additionally, or alternatively, comprise an encrypted wireless network settings object. The encrypted wireless network settings object may comprise one, or both, of an identifier of the network and/or the credential for accessing the network.

The network access manager may receive an authentication token from one of the unauthorized users. The token may be associated with a service provider. The network access manager may validate the token with the associated service provider. Additionally, the network access manager may validate that the identity of the unauthorized user associated with the token is associated with one of the unauthorized users that received the message to join the network. Based on a successful validation of the token and validation of the unauthorized user's identity, the network access manager may send the unauthorized user an unencrypted version of the wireless network settings object, allowing the unauthorized user to access the network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 shows an example system.

FIG. 2 shows an example method.

FIG. 3 shows an example method.

FIG. 4 shows an example method.

FIG. 5 shows an example method.

FIG. 6 shows an example method.

FIG. 7 shows an example computing system.

Aspects of the disclosure will now be described in detail with reference to the drawings, wherein like reference numbers refer to like elements throughout, unless specified otherwise.

### DETAILED DESCRIPTION

In order to provide wireless network access to users (e.g., guests), an authorized user of the network (e.g., a network owner) typically has to supply the user with a wireless network access credential, such as a password, and the user must enter the credential manually in order to gain access to the network. This process can be cumbersome. Sometimes multiple users request access at the same time, and the authorized user must help each user through the process individually. Also, the process may need to be repeated every time the same user attempts to access the network. Additionally, the process typically allows each user to gain access to the identity of the credential, which may increase the risk of the credential falling into the hands of an unwanted entity.

With the proliferation of the internet in everyday life, there are increasingly many online profiles associated with individuals. Individuals are increasingly able to link their online profiles to one another, and/or to a central profile associated with the individual. It is desirable for authorized users on a network to provide a way for unauthorized users to access the network without the authorized user having to reveal the identity of the credential, while also allowing the approach to be scaled to multiple unauthorized users that wish to have access to the network.

Traditional wireless network access methods typically require the authorized user to provide an unencrypted version of the network credential to unauthorized users. The more unauthorized users that have access to the network credential, the more likely that the network may become compromised. Additionally, because the credential may be unencrypted, it may be possible for unauthorized users to share the credential with third parties that were never intended to have access to the wireless network.

As technologies evolve, new systems arise that can more readily link multiple accounts associated with an individual. Additionally, new technologies are increasing the ability for unrelated services to safely authorize an individual without sharing the individual's credential between the services.

Disclosed herein are systems, devices, and methods for more easily sharing access to a wireless network with one or more other users, such as unauthorized users or guests. Access to a wireless network may be provided to one or more users without revealing a network credential to the users. A user authorized to provide access to the network, such as a network owner may share encrypted credentials with users so that even if the credential falls into the wrong hands, it is not revealed to any bad actors.

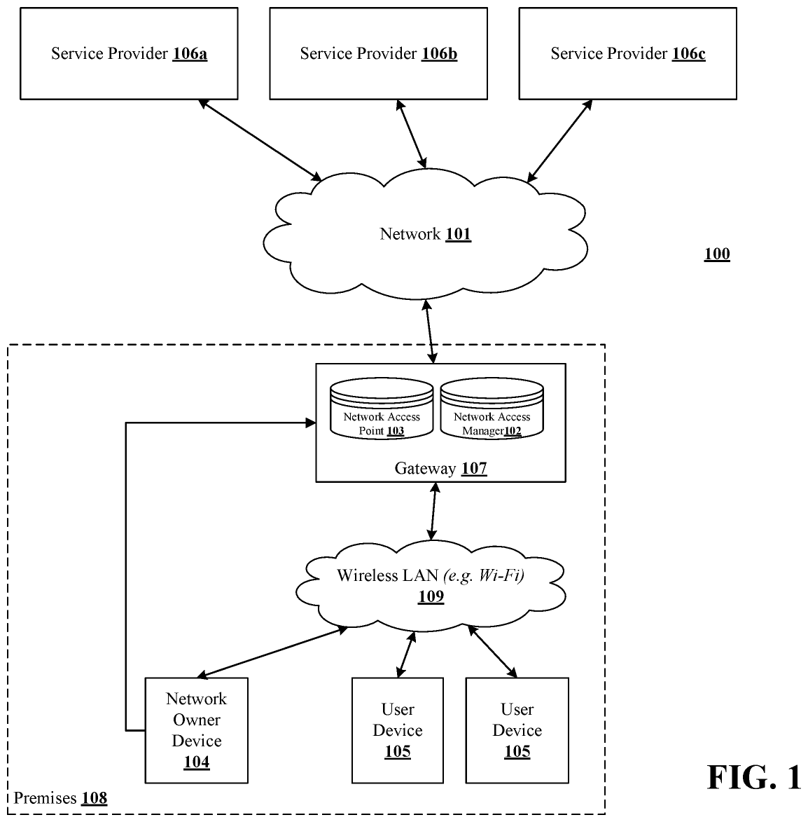

FIG. 1 shows an example system in which the present systems, methods, and apparatus may be implemented. As shown in FIG. 1, a system 100 may comprise at least one network 101, and the network may comprise a network access manager 102 and a network access point 103. The system 100 may further comprise a network owner device 104, one or more user devices 105, and one or more service providers 106. The one or more service provider devices 106 may be one or more trusted entities capable of authenticating a user's identity. The network owner device 104, the one or more user devices 105, and the one or more service providers 106 may be in communication with the network 101.

The network 101 may provide access to one or more user devices, including both user devices associated with the network owner 104 and/or user devices associated with one or more users 105. Non-limiting examples of a network 101 include an internet service provider (ISP) network, a cloud computing network, a local area network (LAN), a Wi-Fi network, a wide area network (WAN), a satellite network, the internet, or any combination thereof. The network can facilitate communication among multiple entities, including the network owner device 104, the user devices 105, service providers 106, and content providers. The network owner device 104 and the user devices 105, that may have access to the network 101, can receive content transmitted from the network 101. Such content may comprise, as non-limiting examples, video data, audio data, text data, or the like.

Video data may comprise any video content produced for viewer consumption. Video content may comprise pre-recorded video programs, live video programs streamed to viewers, or any other video content broadcast to users via radio, cable, satellite, or other method. Audio data may comprise any audio content produced for listener consumption. Audio content can comprise pre-recorded songs or other pre-recorded audio data, live audio programs streamed to listeners, such as a radio talk show, or the like. Text data may comprise any textual or pictorial content produced for viewer consumption. Textual data may comprise, for example, e-books, comics, or other pictures associated with video content.

The network 101 may comprise a network access manager 102 that monitors and authorizes users to access the network. A network access manager 102 may comprise software that detects and manages users attempting to access the network. A network access manager 102 may enforce accessibility to the network 101 through the use of authorizing user identities to allow user access to the network 101. The network access manager 102 may use any number of known protocols to enforce accessibility requirements to allow access to the network 101.

The network 101 may also comprise a network access point 103. The network access point 103 may be a device that transmits and receives data over a wireless network, for example, a wireless local area network (WLAN). The network access point 103 may be implemented as non-transitory computer-readable instructions within the network infrastructure. The network access point 103 may comprise a hardware device itself, that acts as a connection between wireless devices and a wired or wireless network. The network access point 103 may act as a portal for users and devices attempting to gain access to the network 101. For example, the network access point 103 may be implemented within the network 101 by directly wiring the network access point 103 into a wired LAN. The network access point 103 may be wirelessly connected to a LAN. Network access points 103 may support several devices and users attempting to access the network 101 simultaneously.

The system 100 may comprise a gateway 107. The gateway 107 may comprise a computing device. The gateway may comprise a network access manager 102. The gateway 107 may comprise a network access point 103. The gateway 107 may be configured to enable devices at the premises 108 to establish a wired or wireless connection to the gateway 107 for purposes of communicating with the gateway 107 and other network apparatuses beyond the gateway 107, such as the network 101. The gateway 107 may establish the wired or wireless connection to devices at the premises 108 via the network access manager 102 and/or the network access point 103. The gateway 107 may be configured to establish a wired and/or wireless local area network to which devices at the premises 108, such as the network owner device 104 and/or the user device 105 may connect. For purposes of communicating wirelessly, the gateway 107 may implement a wireless access technology, such as the IEEE 802.11 (“Wi-fi”) radio access technology. In other implementations, other radio access technologies may be employed, such as IEEE 802.16 or 802.20 (“WiMAX”), IEEE 802.15.4a (“Zigbee”), or 802.15.3c (“UWB”). For purposes of communicating with the gateway 107 via a wired connection, the gateway 107 may be configured to implement a wired local area network technology, such as IEEE 802.3 (“Ethernet”), or the like.

The gateway 107 may comprise a router. The gateway 107 may comprise a modem. The gateway 107 may be configured to provide a first connection to the network 101 via a service provider network, such as a network operated by a cable television system operator or other communications service provider. The service provider network may comprise any of a variety of types of networks, such as, for example, a coaxial cable network, a fiber-optic cable network, a hybrid fiber-coaxial (HFC) network, a satellite transmission channel, a DSL connection, or the like.

The gateway 107 may be configured to receive data traffic from devices at the premises 108, such as via a Wi-Fi network established by the gateway 107 at the premises 108. The gateway 107 may be configured to route the data traffic to the network 101 via the first connection to the network 101.

The network owner device 104 may be associated with an owner of the network 101. The network owner may also be an authorized user of the network 101. The network owner may connect to the network 101 from a user device 104. The network owner device 104 may comprise any number of user devices. As non-limiting examples, user devices may comprise, for example, a computer, a laptop, a tablet, a mobile phone, a PDA, a gaming console, or the like. The network owner may be associated with a single network owner device 104, or the network owner may be associated with several user devices. If the network owner is associated with several user devices, one or more of the user devices may be able to access the network 101. The network owner may have additional privileges with respect to the network 101 than other users, including unauthorized users and authorized users, both of which may be associated with one or more user devices 105. For example, a network owner may be able to, using the network owner device 104, change settings on the network 101, including, but not limited to, changing the accessibility settings of the network 101, changing a credential associated with accessing the network 101, limiting the number total user devices that may be associated with the network 101 at any one time, limiting the number of total users (regardless of number of user devices) that may be associated with the network 101 at any one time, and so on.

The user device 105 (e.g., guest device) may not be associated with the network 101. The user may not have access to the network 101. The user device 105 may be an unauthorized user device of the network 101. The user device 105 may attempt to connect to the network 101 The user device 105 may be associated with any number of user devices. As non-limiting examples, a user device 105 may comprise a computer, a laptop, a tablet, a mobile phone, a PDA, a gaming console, or the like. The user may be associated with a single user device 105, or the user may be associated with several user devices 105. If the user is associated with several user devices 105, one or more of the user devices 105 may be able to access the network 101. The user device 105 may have less privileges with respect to the network 101 than the network owner device 104. The user device 105 may be one of one or more user devices 105. Each of the user devices 105 may have the same privileges to connect to and/or change settings on the network 101. Alternatively, one or more user devices 105 may have more or less privileges with respect to the network 101 than one or more other user devices 105. For example, a user device 105 may not be able to change settings on the network 101. Alternatively, a different user device 105 may be able to change settings on the network 101, including, but not limited to, changing the accessibility settings of the network 101, changing a credential associated with accessing the network 101, limiting the number total user devices that may be associated with the network 101 at any one time, limiting the number of total users (regardless of number of user devices) that may be associated with the network 101 at any one time, and so on.

The service providers 106 may comprise a single service provider 106 or one or more service providers 106. One service provider 106 may be associated with a single user device 105 or may be associated with one or more user devices 105. Service providers 106 may be entities capable of authenticating an identity associated with a user and/or a user device 105. Service providers 106 may be social media companies, such as Facebook, Twitter, Myspace, or the like. Service providers 106 may be other entities that are associated with the identity of users, such as Google, Apple, Spotify, or the like. A service provider 106 may hold one or more pieces of information associated with the identity of a user. For example, a user may create a profile associated with the user's identity on one service provider 106, Facebook, for example, and the service provider may be able to associate the profile with the identity of the user, or the identity of a user device associated with the user 105. A service provider 106 may correlate personal data related to a user with a profile associated with the service provider 106. In that way, the service provider 106 may create and keep a profile of all known data associated with a single user or other user.

The network access manager 102 may receive and send communications to the network owner device 104. The communications may be sent wirelessly or through a wired connection. The network owner device 104 may communicate with the network 101 via the network access manager 102 to request access for one or more user devices 105 to be authorized to access the network 101. The network access manager 102 may be configured to accept the network owner device's 104 request to grant access to one or more user devices 105.

The network access manager 102 may communicate with the network access point 103 to pass on the request from the network owner device 104 to allow access to the network 101 for one or more user devices 105. The network access manager 102 may provide a credential for accessing the network 101 to the network access point 103. The network access manager 102 may communicate with the one or more user devices 105. In one example, the network access manager 102 may send a message including an invitation to join the network 101 to the one or more user devices 105. In another example, the one or more user devices 105 may send a communication to the network access manager 102 to request access to the network 101.

A user associated with a user device 105 may send a request to a service provider 106 for a token, and the token may authenticate the identity of the user. The service provider 106 may access its own database or any other database it is authorized to access to discover whether the user is associated with the service provider 106. If the service provider 106 finds a profile or database that matches the identity of the user, the service provider may provide an authentication token to the user device 105 associated with the user, indicating that the service provider 106 is associated with the user and/or the user device 105. The authentication token may indicate that the user device 105 is associated with user data associated with the service provider. The user, via the user device 105, may present the token from the service provider 106 and the message comprising the invitation from the network access manager 102 to the network access manager 102 for authorization. The user may present the required information to the network access point 103, or to another module associated with the network 101 for authenticating a user identity or authorizing the user to access the network 101. The user may be authorized and allowed access to the network. The authorization may allow the user to access the network from the user device 105.

The network access manager 102 may allow a user device 105 to access the network 101 in this way, without having to reveal the identity of a password or other credential required to access the network 101. The network access manager 102 may send the credential to the network access point 103, and the network access manager 102 may send the invitation to the user device 105. The invitation may comprise at least one of an indication of the credential and an identity of the network 101. The user device 105 may request an authentication token from a service provider 106. The user device 105 may receive, from the service provider 106, a token authenticating an identity associated with the user device 105. The user may present the token and the invitation to the network access point 103. The network access point 103 may send the token to the service provider 106. The network access point 103 may receive, from the service provider 106, confirmation that the token is valid. The network access point 103 may determine the user device 105 associated with the token is the same user device 105 associated with the invitation. The network access manager 103 may determine to authorize the user device 105 to access the network 101.

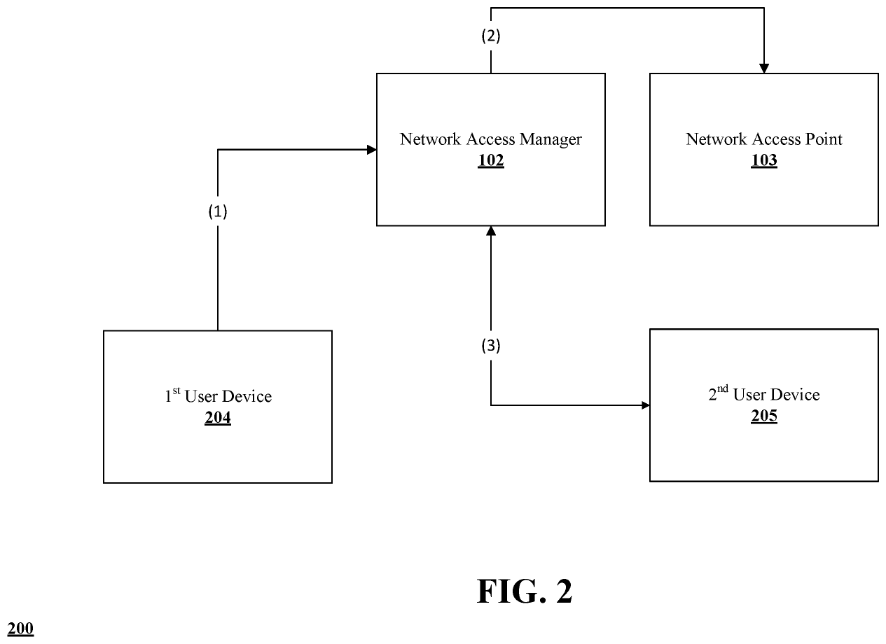

FIG. 2 shows an example method. The method of FIG. 2 may be used to provide an invitation to one or more users to access a network. As shown, a 1^{st} user device 204 may send a message to a network access manager 102 requesting that a 2^{nd} user device 205 be given access to a network associated with the network access manager 102 and the network access point 103. The 1^{st} user device 204 may be associated with an owner of the network. The 1^{st} user device 204 may be associated with an authorized user of the network. The 1^{st} user device 204 may, for example, be the network owner device 104 of FIG. 1. network access manager 102 The 2^{nd} user device 205 may comprise a user device 105 of FIG. 1.

The request from the 1^{st} user device 204 may comprise an identification of the 2^{nd} user device 205 to be granted access to the network. The identification of the 2^{nd} user device 205 may comprise any identifier that properly identifies a user and/or a user device. As non-limiting examples, the identification may comprise an email address of the user, a cell phone number associated with the 2^{nd} user device 205, a cell phone number associated with the user different than the cell phone number associated with the user device 205, an identifier associated with a social media platform and the user, or the like. In this way, the network access manager 102 may be able to instruct the network access point 103 about which user or user device to allow access to the network. The network access manager 102 may receive the request from the 1^{st} user device 204. The network access manager 102 may generate a cryptographically strong random passphrase or other credential. The passphrase may be a WPA2 or WPA3 passphrase, for example. The network access manager 102 may send the passphrase or credential to the network access point 103.

The network access manager 102 may send a message to the 2^{nd} user device 205 with an invitation to join the network. The invitation may comprise a payload, or other information, including an encrypted object. The object may be a Wi-Fi settings object, or any other suitable object. The invitation and/or payload may also comprise an address to be used to initiate the process of the joining the network. For example, the address may be a uniform resource locator (URL) that directs the 2^{nd} user device 205 to a specific web page. The web page may comprise instructions or information to allow the 2^{nd} user device 205 to begin the process of accessing the network. The object may comprise an identifier of the network. For example, the identifier may be a Service Set Identifier (SSID) of a wireless network. The identifier may be any other identifier suitable for identifying a network, including, for example, a LAN, a WAN, a satellite network, or the like. The object may also, or alternatively, comprise the credential created by the network access manager 102. The object may also comprise all three of these features. That is, the object may comprise an address to be used to initiate the process of joining the network, the identifier of the network, and the credential necessary to gain access to the network. The object may also comprise any additional information useful for authorization of a user device on a network. For example, the object may also comprise a basic service set identifier (BSSID) of a network or an authorization key management (AKM) suite.

While FIG. 2 shows a 1^{st} user device 204 and a 2^{nd} user device 205, it is understood that there may be other user devices associated with the network owner and there may be additional user devices desiring to access the network. For example, multiple user devices may send requests to the network access manager 102 requesting that a single user device be given access to the network. Alternatively, or in combination, one or more user devices may request access for multiple other user devices to have access to the network. Such examples are non-limiting and merely meant to provide additional examples of how user devices may request access to the network for other, unauthorized user devices.

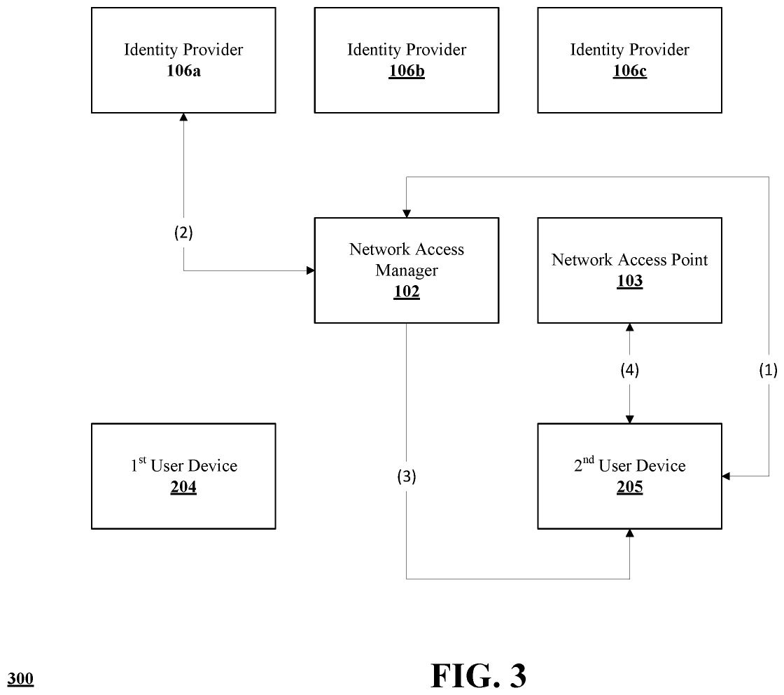

FIG. 3 shows another example method. The method of FIG. 3. may be used to validate a credential associated with a user and to provide the user access to a network. The method of FIG. 3 may be performed in conjunction with the method of FIG. 2. The method of FIG. 3 may be performed after the method of FIG. 2.

As shown in FIG. 3, a 2^{nd} user device 205 may send a request to a service provider 106c associated with the 2^{nd} user device 205 to request a token. The token may comprise any type of token used to authorize the identity of a user. As one non-limiting example, the token may comprise an Open Authentication token (OAuth token). The service provider 106c may search internally to determine whether the 2^{nd} user device 205 is associated with the service provider 106c. If the service provider 106c determines that the 2^{nd} user device 205 is associated with the service provider 106c, it may return a token to the 2^{nd} user device 205. The 2^{nd} user device 205 may request access to the network and may send the token to the network access manager 102. Additionally, or alternatively, the 2^{nd} user device 205 may send the object that it receives from the network access manager 102 back to the network access manager 102.

The network access manager 102 may present the token to the indicated service provider 106c that supplied the token to the 2^{nd} user device 205 to check for validity of the token and authenticate the identity of the 2^{nd} user device 205. The network access manager 102 may receive information that the token is invalid with respect to the service provider 106c. The network access manager 102 may deny the 2^{nd} user device 205 access to the network. The network access manager 102 may receive information that the token is a valid token associated with the service provider 106c. The network access manager 102 may validate the identity of the 2^{nd} user device 205. The network access manager 102 may compare the identity of the 2^{nd} user device 205 according to the identity presented in the token with the identity associated with the object that the 2^{nd} user device 205 returned to the network access manager 102. The network access manager 102 may determine the identities in both the token and the returned object match. The network access manager 102 may send a decrypted form of the object to the 2^{nd} user device 205. The 2^{nd} user device 205 may extract the information in the object. The information in the object may comprise any one or more of: the address to be used to initiate the process of joining the network, the identifier of the network, and the credential necessary to access the network. The information in the object may additionally, or alternatively comprise a BSSID, an AKM suite, or any other information useful for authorization with the network. The 2^{nd} user device 205 may use the decrypted information to access the network. The information may be automatically presented from the 2^{nd} user device 205 to the network access point 103 or to the network access manager 102 in order to grant access to the network for the 2^{nd} user device 205 without revealing the information in the object to any one or more users associated with the 2^{nd} user device 205.

While FIG. 3 shows a 1^{st} user device 204 and a 2^{nd} user device 205, it is understood that there may be other user devices associated with the network owner and there may be additional user devices desiring to access the network. For example, multiple user devices may send requests to the network access manager 102 requesting that a single user device be given access to the network. Alternatively, or in combination, one or more user devices may request access for multiple other user devices to have access to the network. Such examples are non-limiting and merely meant to provide additional examples of how user devices may request access to the network for other, unauthorized user devices.

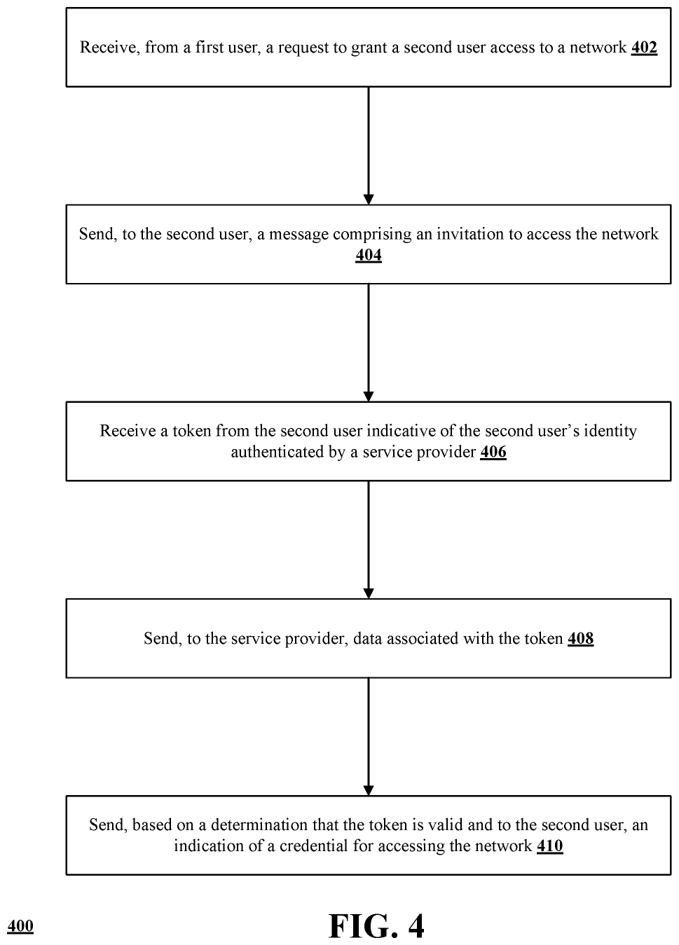

FIG. 4 shows an example method 400. The method 400 may be used to provide a user device access to a network. The method may be performed, for example, by a network access manager 102. A first user may have access to the network. The first user may be an owner of the network, or the first user may be any user authorized to make changes to and/or to invite additional users to access the network. The first user may access the network via a first user device 204. The first user device may comprise, for example, a desktop computer, a laptop computer, a tablet, a mobile device, a PDA, a gaming console, or the like.

The method 400 may be used to provide access to the network for a second user not initially authorized to access the network. The second user may be one user of one or more users that are not authorized to access the network. The second user may be, for example, a guest at the location associated with the network. For example, the second user may be located at a premises served by the network at that premises.

The first user may be associated with one user device on the network, or the first user may be associated with multiple user devices on the network. The first user may only be able to request access on the network for the second user using a specific user device, or a specific set of user devices. The first user may be able to request access on the network for the second user using any user device. The first user may request access on the network for the second user. The second user may be able to authorize and access the network for a specified period of time. For example, the second user may have 24 hours to authorize and access the network upon the first user requesting access on the network for the second user. The second user may only be able to access the network during a specified window of time. In one example, the second user may only be able to access the network for a 12 hour period, a 24 hour period, a 48 hour period, or a one week period after the first user requests access on the network for the second user.

At step 402, a network access manager, or other component of a network, may receive a request from a first user to grant a second user access to the network. The network access manager may be a set of computer readable instructions that provide for device authorization for access to the network. The network access manager may operate a series of policies to determine when unauthorized users are authorized to access the network. The first user may be authorized to grant access to other, unauthorized users to gain access to the network. In such a scenario, the network access manager may begin the process of allowing the second user to gain access to the network.

The network access manager may determine a passphrase or a credential required for accessing the network. The passphrase or credential may, as non-limiting examples, be WPA2 or WPA3 passphrases. The credential may be a cryptographically strong credential to prevent a breach of the credential, which could allow access to the network to an unauthorized entity. The credential may be randomly generated by the network access manager.

At step 404, the network access manager may send a message to the second user. The message may comprise an invitation to join the network. Alternatively, other components in the network may send the message and invitation to the second user. Additionally, the second user may be one user of one or more users. The network access manager may send the message with an invitation to join the network to multiple, or to each of the users of the one or more users. The message may be the same for all users. The message may be different for each user, or different for some of the users of the one or more users. Additionally, the invitation may be the same in each message, or the invitation may be different for some, or all of the one or more users.

At step 406, the network access manager may receive a token indicative of a service provider from the second user. The token may be indicative of an identity of the user from the service provider. For example, the service provider may be a social media platform. As another example, the service provider may be Google. The token may be an authentication token, such as an OAuth token. The token may serve to identify the second user's identity without revealing the second user's personal data to the network or the network access manager.

The second user may be one user of one or more users that are not authorized on the network and are not authorized to access the network. Where there are multiple unauthorized users, each of the unauthorized users may present a token to the network or the network access manager. Each token may represent the identity of the unauthorized user that provided the token to the network access manager. In one example, each of the unauthorized users present a token from the same service provider. Alternatively, some, or all of the tokens presented by the unauthorized users may come from different service providers.

Each of the tokens may be of the same type. For example, each token may be an OAuth 2.0 token. The tokens may be of different types. For example, one or more tokens presented by one or more unauthorized users may be bearer scheme tokens, such as an OAuth 2.0 token, while other types of tokens presented may be of a different type, such as a digest scheme token, for example an OAuth 1.0 token.

At step 408 the network access manager may send the received token to the associated service provider. For example, the second user may request a token from a social media platform and provide the token to the network access manager. The network access manager may provide the token to the social media platform for validation. The validation may involve requesting the social media platform to confirm or deny a validity of the token.

If, for example, the service provider responds with a denial that the token is valid, the network access manager may determine that the second user is not authorized to access the network. If the token is determined valid, the method may continue to step 410

At step 410, the network access manager may determine that the second user is authenticated. The network access manager may determine that the second user is authorized to access the network. The network access manager may send the credential associated with accessing the network to the second user. The credential may be a cryptographically strong passphrase necessary to access the network. In some cases, the credential may comprise an identifier of the network, such as the network SSID. In other cases, the credential may comprise both the network identifier and the passphrase or other password necessary to access the network.

The network access manager may provide the credential to the second user in an accessible format. For example, the credential may be sent to the second user in an unencrypted format, so that the second user may present the unencrypted credential to any suitable component associated with the network to gain access to the network. In some examples, the second user may provide the credential to a network access point. The network access point may accept the credential, and if it matches a credential previously supplied to the network access point, the network access point may allow the second user to access the network.

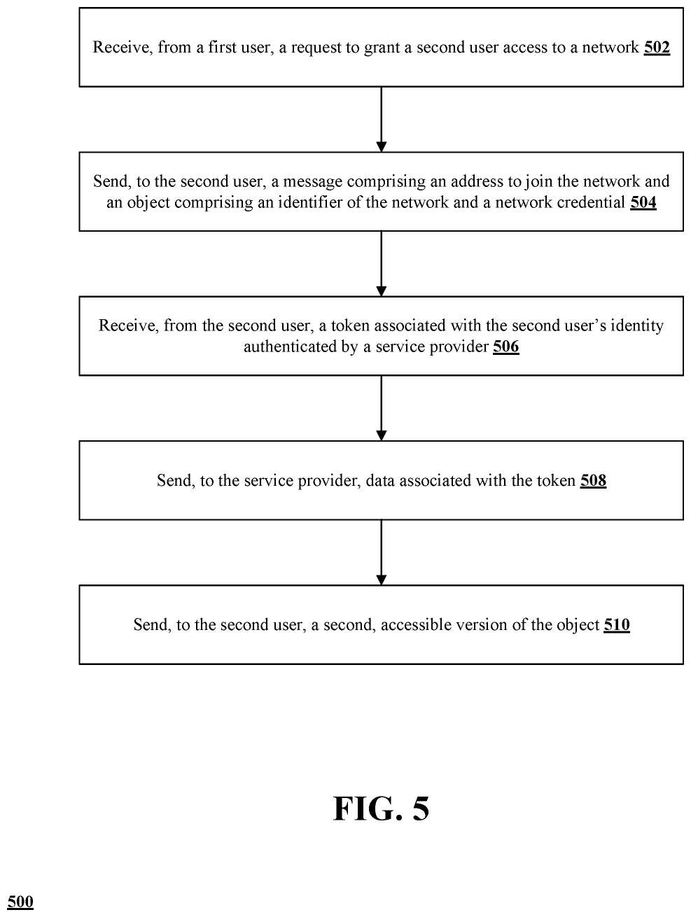

FIG. 5 shows an example method 500. The method 500 may be used to provide an invitation to one or more users to access a network. The method may be performed, for example, by a network access manager, such as the network access manager 102 of FIG. 1. The method 500 may be performed to receive a request for a user to gain access to a network and to provide the user with an invitation to join the network. The method 500 may be performed to receive a request from a first user already authorized on the network, wishing to grant authorization to a second user to access the network. The second user may be granted access to the network for a specified period of time, during a specified window of time, indefinitely, or the like.

At step 502, a network access manager of a network may receive a request from a first user to grant access to the network to a second user. The first user may be an owner of the network, or the first user may be authorized to request access to the network for other users. The second user may be an unauthorized user on the network.

The network access manager may generate a credential associated with gaining access to the network. The credential may be a cryptographically strong passphrase required to gain access to the network. The network access manager may send an indication of the credential to a network access point associated with the network. The credential may be associated with an individual user, a specific group of users, or all users. For example, the network access manager may generate a first credential associated with a first user. The network access manager may generate a second credential associated with a second user. The network access manager may send either one, or both, of the first credential and the second credential to the wireless access point. The network access point may be a computing device configured to allow certain users access to the network. The network access point may be wirelessly connected to the network, or the network access point may be connected to the network in a wired fashion. The network access point may allow several users and/or user devices to access the network at a same time, or the network access point may only allow a single user to access the network at a time.

At step 504, the network access manager may generate a message. The message may comprise an invitation to join the network. The message and the invitation may be generated for the second user so that the second user can gain access to the network. The message and/or the invitation may comprise an address associated with initiating the process of joining the network. The address may be a URL, or it may be any other address. The message and/or the invitation may also comprise an object. The object may be a Wi-Fi settings object. The object may comprise an identifier of the network. In one example, the identifier may be an SSID of the network. The object may also comprise the credential generated by the network access manager. The object may be encrypted. The object may also comprise additional information helpful in authorizing a user at a network, including a BSSID, an AKM suite, or the like.

The network access manager may send the message to the second user. The message and the invitation may allow the second user to initiate a procedure to access the network, and the message and invitation may comprise information necessary to obtain authorization to access the network. The second user may be one user of one or more users attempting to gain access to the network. The message and invitation may be the same for each user of the one or more users. The message and invitation may be the same for some users of the one or more users and the message and invitation may be different for some users of the one or more users. The message and invitation may be different for each of the users of the one or more users.

At step 506, the network access manager may receive a token from the second user. The token may be associated with a service provider of one or more service providers. The token may indicate an authentication of an identity associated with the second user. The second user may be an individual user requesting access to the network. The steps performed herein may be directed toward an individual, unauthorized user. The second, unauthorized user may be one user of one or more unauthorized users. The network access manager may receive a token from each one of the unauthorized users of the one or more unauthorized users. More than one unauthorized user may send a token to the network access manager, but less than all of the unauthorized users may send a token to the network access manager. The unauthorized users that do not send a token to the network access manager may not be able to access the network.

Where the network access manager receives multiple tokens (one token each from multiple unauthorized users), the tokens may all originate from the same service provider. The tokens may come from one or more service providers, up to the point where each token may originate from a different service provider of the one or more service providers. The network access manager may validate each token with the service provider associated with each token. The token may represent an authentication token, such as an OAuth 2.0 token, or any other suitable token.

At step 508, the network access manager may send, to the service provider, data associated with the token to determine a validity of the token. The network access manager may receive multiple tokens from one or more service providers. The network access manager may attempt to validate each token individually with the service provider associated with each individual token. An unauthorized user may present multiple tokens. The multiple tokens may each be from the same service provider, or the multiple tokens may each be from different service providers.

Furthermore, the network access manager may attempt to validate the token with the service provider associated with the token, and the token may be invalid. The network access manager may reject the unauthorized user from accessing the network based on the invalid token. In some cases, the unauthorized user may return to the service provider to attempt to obtain a new token to validate the unauthorized user's identity. In some cases, the new token may be the same token as the first token. In some cases, the new token may be a different token associated with the same service provider, or the new token may be associated with a different service provider.

At step 510, the network access manager may validate that the unauthorized user is associated with an object that was provided to the unauthorized user. For example, in the message sent to an unauthorized user, the message may comprise an invitation, and the message and/or the invitation may comprise an object. The object may comprise an identifier of the network and/or a credential necessary to gain access to the network. Additionally, the object may comprise any other information relevant in authorizing a user to access the network.

The message originally sent to the unauthorized user may comprise an encrypted object. The network access manager may receive the token and the object from the unauthorized user. The network access manager may send a different version of the object to the unauthorized user. The different version of the object may be an unencrypted version of the object.

The different version of the object sent to the unauthorized user may comprise an accessible version of an identifier of the network. The different version of the object sent to the unauthorized user may comprise an accessible version of a credential associated with the network. The different version of the object may comprise both the accessible version of the network identifier and the accessible version of the credential associated with the network. An accessible version of either the network identifier and/or the credential associated with the network may be an unencrypted version of the network identifier and the credential associated with the network. In one example, the network access manager may validate tokens and object with several unauthorized users of one or more unauthorized users. In that case, the network access manager may send the accessible version of the network identifier and the accessible version of the credential associated with the network to each of the validated unauthorized users.

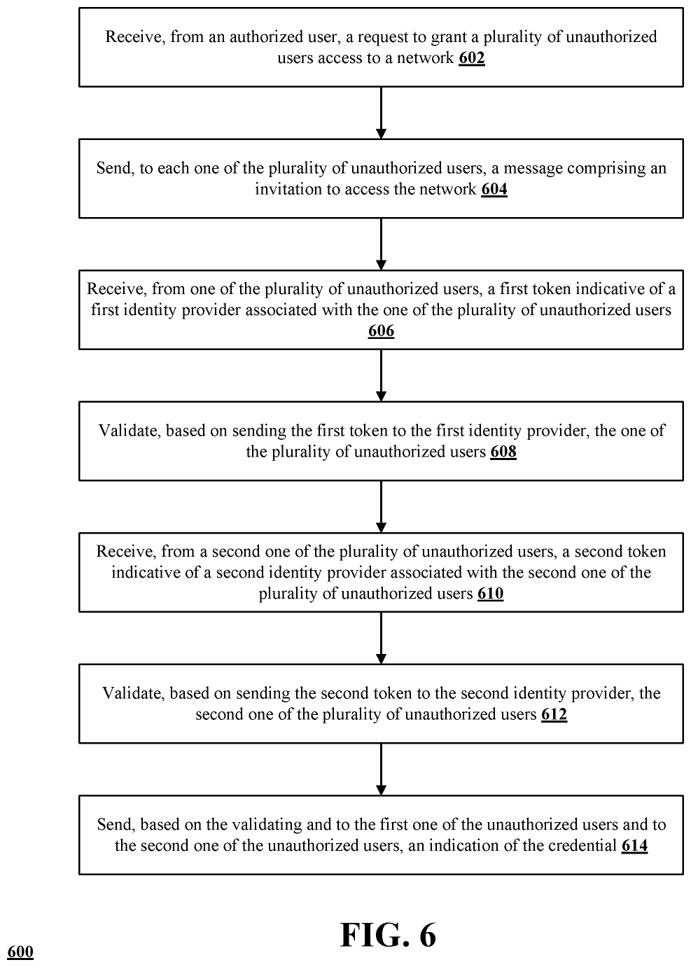

FIG. 6 shows an example method 600. The method 600 may be performed, for example, by the network access manager 102 of FIG. 1. The method 600 may be performed to accept a request from an authorized user to grant access to a plurality of unauthorized users desiring authorization to access to a network. The authorized user may be an owner of the network, or the authorized user may be a user authorized to make changes and/or to invite additional users to access the network. The authorized user may access the network via a user device. A user device can comprise, for example, a desktop computer, a laptop computer, a tablet, a mobile device, a PDA, a gaming console, or the like. The plurality of unauthorized users may each be associated with a same or a different user device as the authorized user.

The plurality of unauthorized users may be one or more unauthorized users not authorized to access the network. The plurality of unauthorized users may be located at the location associated with the network. For example, the plurality of unauthorized users may each be located at a premises served by a Wi-Fi or other network, including a wired network. The plurality of unauthorized users may each be located at a different location than the network. One or more of the plurality of unauthorized users may be located at the location associated with the network, while one or more of the plurality of unauthorized users may be located at a different location than the network. Additionally, each one of the plurality of unauthorized users may be located at either the same location or at a different location than the authorized user in any combination. The authorized user and the plurality of unauthorized users may use the same user device to access the network. Alternatively, the authorized user and the plurality of unauthorized users may each use different user devices to access the network.

The authorized user may be associated with one user device on the network, or the authorized user may be associated with multiple user devices on the network. The authorized user may only be able to request access on the network for one or more of the plurality of unauthorized users using a specific user device, or a specific set of user devices. The authorized user may be able to request access on the network for any one of the plurality of unauthorized users using any user device. The authorized user may request access on the network for one or more of the plurality of unauthorized users, the one or more of the plurality of unauthorized users may only be able to authorize access on the network for a specified period of time. For example, the one or more of the plurality of unauthorized users may have 24 hours to authorize and access the network after the authorized user requests access on the network for the plurality of unauthorized users. The one or more of the plurality of unauthorized users may only be able to access the network during a specified window of time. In one example, the one or more of the plurality of unauthorized users may only be able to access the network for a 12 hour period, a 24 hour period, a 48 hour period, or a one week period after the authorized user requests access on the network for the plurality of unauthorized users.

At step 602, a network access manager, or other component of a network, may receive a request from an authorized user to grant a plurality of unauthorized users access to the network. The network access manager may be a set of computer readable instructions that provide for device authorization for access to the network. The network access manager may operate a series of policies to determine when unauthorized users are authorized to access the network. The authorized user may be authorized to grant access to other, unauthorized users to gain access to the network. In such a scenario, the network access manager may begin the process of allowing the plurality of unauthorized users to gain access to the network.

At step 604, the network access manager may send, to each of the plurality of unauthorized users, a message. The network access manager may send the same message to each of the plurality of unauthorized users, or the network access manager may send multiple different messages to some, or all of the plurality of unauthorized users. The message may comprise an invitation to access the network. Other components in the network may send the message and the invitation to the plurality of unauthorized users. Additionally, the invitation in the message may be the same in each message, or the invitation may be different for some, or all of the unauthorized users in the plurality of unauthorized users.

The invitation may comprise an object, the object optionally further comprising an identifier of the network and/or a credential associated with accessing the network. The network access manager may determine the credential required for accessing the network. The passphrase or credential may, as non-limiting examples, be WPA2 or WPA3 passphrases. The credential may be a cryptographically strong credential to prevent a breach of the credential, which could allow access to the network to an unauthorized entity. The credential may be randomly generated by the network access manager. The identifier of the network may be an S SID or other piece of information that accurately identifies the network.

At step 606, the network access manager may receive a token indicative of a service provider from a first one of the plurality of unauthorized users. The token may be indicative of an identity of the first one of the plurality of unauthorized users from the service provider. For example, the service provider may be a social media platform. As another example, the service provider may be any entity that collects and/or identifies personal information associated with users. The token may be an authentication token, such as an OAuth token. The token may serve to identify the first one of the plurality of unauthorized user's identity without revealing the first one of the plurality of unauthorized user's personal data to the network or the network access manager.

At step 608 the network access manager may send the received token to the service provider associated with the token. For example, the first one of the plurality of unauthorized users may request a token from a social media platform and provide the token to the network access manager. The network access manager may provide the token to the social media platform to validate the first one of the plurality of unauthorized user's identity. The validation may comprise requesting the social media platform to confirm or deny a validity of the token.

If, for example, the service provider responds with a denial that the token is valid, the network access manager may determine that the first one of the plurality of unauthorized users is not authorized to access the network. If the token is determined valid, the method may continue to step 610.

At step 610, the network access manager may receive a token indicative of a service provider from a second one of the plurality of unauthorized users. The token may be indicative of an identity of the second one of the plurality of unauthorized users from the service provider. For example, the service provider may be a social media platform. As another example, the service provider may be any entity that collects and/or identifies personal information associated with users. The token may be an authentication token, such as an OAuth token. The token may serve to identify the second one of the plurality of unauthorized user's identity without revealing the second one of the plurality of unauthorized user's personal data to the network or the network access manager.

At step 612, the network access manager may send the received token to the service provider associated with the token. For example, the second one of the plurality of unauthorized users may request a token from a social media platform and provide the token to the network access manager. The network access manager may provide the token to the social media platform for validation of the second one of the plurality of unauthorized user's identity. The validation may involve requesting the social media platform to confirm or deny a validity of the token.

If, for example, the service provider responds with a denial that the token is valid, the network access manager may determine that the second one of the plurality of unauthorized users is not authorized to access the network. If the token is determined valid, the method may continue to step 614.

At step 614, the network access manager may send an indication of the credential associated with accessing the network to both the first and the second ones of the plurality of users. The credential may be a cryptographically strong passphrase necessary to access the network. In some cases, the credential may comprise an identifier of the network, such as the network SSID. In other cases, the credential may comprise both the network identifier and the passphrase or other password necessary to access the network.

The network access manager may provide the indication of the credential to both the first and the second ones of the plurality of unauthorized users in an accessible format. For example, the credential may be sent to both the first and the second ones of the plurality of unauthorized users in an unencrypted format, so that the first and second ones of the plurality of unauthorized users may present the unencrypted credential to the network to gain access to the network. In some examples, the first and second users of the plurality of unauthorized users may provide the credential to a network access point. The network access point may accept the credential, and if the credential matches a credential previously supplied to the network access point, the network access point may allow the first and the second users of the plurality of unauthorized users to access the network.

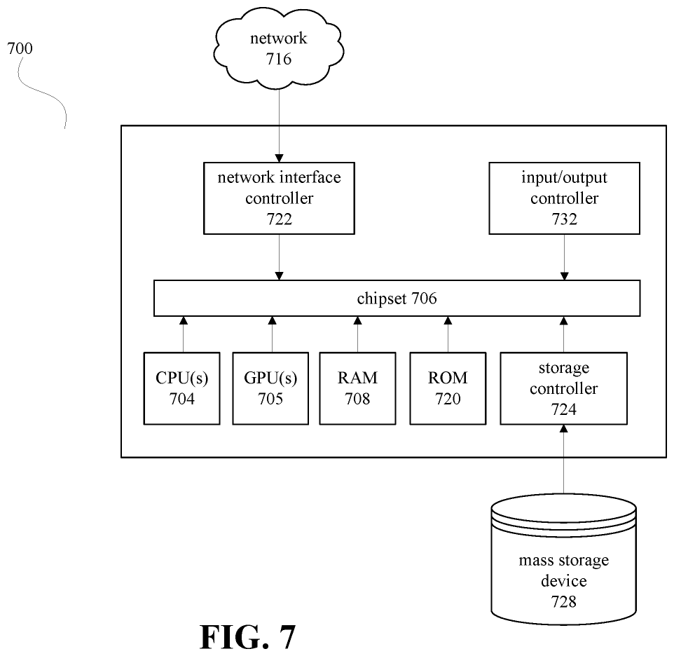

FIG. 7 shows an example computing device 700 that may represent any of the various devices or entities shown in FIG. 1, including, for example, the network 101, the network owner device 104, the user device 105, or the service providers 106. That is, the computing device 700 shown in FIG. 7 may be any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 4-6.

The computing device 700 may comprise a baseboard, or “motherboard,” which is a printed circuit board to which a multitude of components or devices may be connected by way of a system bus or other electrical communication paths. One or more central processing units (CPUs or “processors”) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random-access memory (RAM) 708 used as the main memory in the computing device 700. The chipset 706 may provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems of the system 100. The chipset 706 may comprise functionality for providing network connectivity through a network interface controller (NIC) 722. A NIC 722 may be capable of connecting the computing device 700 to other computing nodes over the system 100. It should be appreciated that multiple NICs 722 may be present in the computing device 700, connecting the computing device to other types of networks and remote computer systems. The NIC 722 may be configured to implement a wired local area network technology, such as IEEE 802.3 (“Ethernet”) or the like. The NIC 722 may also comprise any suitable wireless network interface controller capable of wirelessly connecting and communicating with other devices or computing nodes on the system 100. For example, the NIC 722 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 700 may be connected to a mass storage device 728 that provides non-volatile storage (i.e., memory) for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 728 is characterized as primary or secondary storage or the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may read information from the mass storage device 728 by detecting the physical states or characteristics of one or more particular locations within the physical storage units.

In addition to the mass storage device 728 described herein, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described herein. The computing device 700 may have access to computer-readable storage media storing computer-executable instructions, which, when executed by the computing device 700, may perform the methods described in relation to FIGS. 4-6.

A computing device, such as the computing device 700 depicted in FIG. 7, may also comprise an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not comprise all of the components shown in FIG. 7, may comprise other components that are not explicitly shown in FIG. 7, or may utilize an architecture completely different than that shown in FIG. 7.

As described herein, a computing device may be a physical computing device, such as the computing device 700 of FIG. 7. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.”. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, from a first user, a request to grant a second user access to a network;
sending, to the second user, a message comprising an indication to access the network;
receiving, from the second user, a token indicative of a service provider associated with the second user, wherein the service provider authenticates an identity of the second user;
sending, based on the receiving the token, and to the service provider, data associated with the token; and
sending, based on a determination that the token is valid and to the second user, an indication of a credential for accessing the network.

2. The method of claim 1, wherein the first user is an owner of the network and wherein the second user is an unauthorized user on the network.

3. The method of claim 1, wherein the token is an open authentication token associated with the second user.

4. The method of claim 1, further comprising:
receiving, from the first user, a request to grant one or more additional users access to the network;
sending, to the one or more additional users, the message;
receiving, from at least one of the additional users, a different token indicative of a different service provider associated with the at least one of the additional users;
sending, based on the receiving the different token, and to the different service provider, data associated with the different token; and
sending, based on an additional determination that the different token is valid and to the at least one of the additional users, the indication of the credential for accessing the network.

5. The method of claim 1, wherein the message comprising the invitation further comprises a Wi-Fi settings object comprising:
an identifier associated with the network; and
the credential.

6. The method of claim 1, wherein the service provider comprises a social media entity.

7. The method of claim 1, further comprising:
receiving, from a different user, a second token indicative of a second service provider;
determining that the identity of the different user associated with the second token is different than the identity of the second user; and
preventing access, by the different user, to the indication of the credential.

8. A method comprising:
receiving, from a first user, a request to grant a second user access to a network;
sending, to the second user, a message comprising:
an address associated with the network; and
an object comprising at least an identifier of the network and a credential for accessing the network;
receiving, from the second user, a token indicative of the second user's identity authenticated by a service provider;
sending, to the service provider, data associated with the token; and
sending, based on a determination that the token is valid, to the second user, a second object comprising at least one of an accessible version of the identifier of the network or an accessible version of the credential.

9. The method of claim 8, wherein the service provider is a social media entity.

10. The method of claim 8, wherein the first user is an authorized user on the network and wherein the second user is an unauthorized user on the network.

11. The method of claim 8, wherein the first object is encrypted prior to the sending the invitation to the second user.

12. The method of claim 8, wherein the of the second object is an unencrypted version of the first object.

13. The method of claim 8, wherein the token is an open authentication token associated with the second user.

14. The method of claim 8, further comprising:
receiving, from a third user, a second token indicative of a second service provider;
determining that the identity of the third user associated with the second token is different than the identity of the second user; and
preventing access, by the third user, to the indication of the credential.

15. A method comprising:
receiving, from an authorized user, a request to grant a plurality of unauthorized users access to a network;
sending, to each one of the plurality of unauthorized users, a message comprising an invitation to access the network;
receiving, from a first one of the plurality of unauthorized users, a first token indicative of a first service provider associated with the first one of the plurality of unauthorized users;
determining, based on sending the first token to the first service provider, a validity of an identity of the first one of the plurality of unauthorized users;
receiving, from a second one of the plurality of unauthorized users, a second token indicative of a second service provider associated with the second one of the plurality of unauthorized users;
determining, based on sending the second token to the second service provider, a validity of an identity of the second one of the plurality of unauthorized users; and
sending, based on the determining, to the first one of the unauthorized users and to the second one of the unauthorized users, an indication of the credential.

16. The method of claim 15, further comprising:
receiving, from a third one of the plurality of unauthorized users, a third token indicative of a third service provider;
determining that the token is invalid; and
preventing access, of the third one of the plurality of unauthorized users, to the indication of the credential.

17. The method of claim 15, further comprising:
receiving, from a different user, a fourth token indicative of a fourth service provider;
determining that the identity of the different user associated with the fourth token is different than each of the identities of the plurality of unauthorized users; and
preventing access, of the different user, to the indication of the credential.

18. The method of claim 15, the invitation further comprising:
an address associated with joining the network; and
an object comprising at least an identifier of the network and the credential.

19. The method of claim 15, wherein the first service provider is a first social media entity, and wherein the second service provider is a second, different social media entity.

20. The method of claim 16, further comprising encrypting the object prior to the sending the message to the at least one of the plurality of unauthorized users.
